(19) United States
(12) Patent Application Publication
(10) Pub. No.: US 2006/0253669 A1
(43) Pub. Date: Nov. 9, 2006

(54) Method and apparatus for providing a transportable storage area network

(76) Inventor: Scott Lobdell, Roswell, GA (US)

Correspondence Address: Crawford Maunu PLLC, Suite 390, 1270 Northland Drive, St. Paul, MN, 55120, US

(21) Appl. No.: 11/124,668

(22) Filed: May 9, 2005

(51) Int. Cl. G06F 12/16

(52) U.S. Cl. 711/162

(57) ABSTRACT

A method and apparatus for providing a transportable storage area network is disclosed. The components of a transportable storage area network are provided in an enclosure that may be moved to a remote site for data collection. The transportable storage area network is further configured for ease of handling, setup and data processing.

### BACKGROUND OF THE INVENTION

1. Field of the Invention

This invention relates in general to networked storage, and more particularly to a method and apparatus for providing a transportable storage area network.

2. Description of Related Art

The use of computers, especially personal computers, is becoming increasingly sweeping because the computer has become an important tool of most areas of business. Rapid technological advancements have opened up many new applications that have up to now been unavailable or too expensive. These personal computers may be used as stand-alone workstations (high end individual personal computers) or linked together in a network by a network server.

The development of Fibre Channel as a networking technology designed specifically for storage resources has been a primary stimulus in the ongoing development of Storage area network (SAN) technology. A SAN links different kinds of storage resources with associated data servers on behalf of a larger network of users represented by client computers. Typically, the SAN uses Fibre Channel technology to facilitate high bandwidth communication between the storage resources and the data servers. The storage resources are usually implemented using physical data storage configurations such as Redundant Arrays of Inexpensive Disks (RAID), simple disk arrays, and complex disk subsystems.

SAN technologies, coupled with the changing needs of users, are causing the demand for storage to accelerate. Consequently, this has increased the basic requirement of managing, storing, and accessing storage resources in a SAN.

The first step in developing a SAN is to pinpoint the applications to be addressed. A SAN may have any number of clients attached to it. The SAN is typically installed in a server room, IT center or server closet within the building housing the SAN. In addition, the SAN can be implemented such that different components of the SAN are in different physical locations. Typical SANs are highly localized having multiple server or host computer systems communicating with each other and sharing one or more storage subsystems and possibly tape, optical or other backup media changers.

A typical SAN involves the linking of at least one server and typically, a plurality of workstations coupled together by a LAN. The link may be established using network cables between the computer workstations and server, or through radio frequency or carrier means. Setup of a SAN involves placing individual hardware components where needed, supplying power to each component, and establishing communications between the components. These components may require special configuration or have differing physical operating requirements in order to function together. Ad hoc installation of various components of the SAN requires skilled technicians, special tools, and good preplanning or a ready source for needed items to get the networked computer system operational. Thus, rapid setup for temporary, portable, or emergency SAN applications may be difficult or even impossible. Further, there are a number of situations where the use of a SAN is required, but the data to be stored is too large or unwieldy for transportation to the SAN location. There may also be situations where the collection of data is performed, but the scale of the data is too large for current practices.

It can be seen then that there is a need for a method and apparatus for providing a transportable storage area network (TSAN).

### SUMMARY OF THE INVENTION

To overcome the limitations in the prior art described above, and to overcome other limitations that will become apparent upon reading and understanding the present specification, the present invention discloses a method and apparatus for providing a transportable storage area network.

The present invention solves the above-described problems by providing components of the transportable storage area network in an enclosure that may be moved to a remote site for data collection. The transportable storage area network is further configured for ease of handling, setup and data processing.

A transportable storage area network in accordance with an embodiment of the present invention includes an enclosure, at least one Fibre Channel device, disposed within the enclosure, for coupling to remote data devices and at least one internal storage device, coupled to the at least one Fibre Channel device, the at least one internal storage device imaging data volumes of the remote data devices.

In another embodiment of the present invention, a method for providing data collection via a transportable storage area network is provided. The method includes coupling a targeted storage area network to a Fibre Channel switch of a transportable storage area network, providing server operations at a gateway coupled to the Fibre Channel switch in the transportable storage area network to allow the gateway to access volumes in the targeted storage area network and copying data from the targeted storage area network to an image destination volume in the transportable storage area network via the gateway.

These and various other advantages and features of novelty which characterize the invention are pointed out with particularity in the claims annexed hereto and form a part hereof However, for a better understanding of the invention, its advantages, and the objects obtained by its use, reference should be made to the drawings which form a further part hereof and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a storage area network (SAN) according to an embodiment of the present invention;

FIG. 2 is a functional diagram of data collection using a transportable SAN according to an embodiment of the present invention;

FIG. 3 is a functional diagram of data collection from an on-site SAN using a transportable SAN according to an embodiment of the present invention;

FIG. 4 is a flow diagram showing data flow during gateway based collection according to an embodiment of the present invention'

FIG. 5 is a functional diagram of data collection from an on-site network attached storage (NAS) and network computers using a transportable SAN according to an embodiment of the present invention;

FIG. 6 is a functional diagram showing examination, analysis, processing, etc. of data on a transportable SAN according to an embodiment of the present invention;

FIG. 7 is a functional diagram showing a mode for copying of TSAN volumes to stationary office SANs according to an embodiment of the present invention;

FIG. 8 is a functional diagram showing flow of data from TSAN volumes to tape backup using image mirrors according to an embodiment of the present invention;

FIG. 9 is a diagram of TSAN components according to an embodiment of the present invention; and

FIG. 10 is a flow chart of the method for providing a transportable SAN according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method and apparatus for providing a transportable storage area network. The components of the transportable storage area network are provided in an enclosure that may be moved to a remote site for data collection. The transportable storage area network is further configured for ease of handling, setup and data processing.

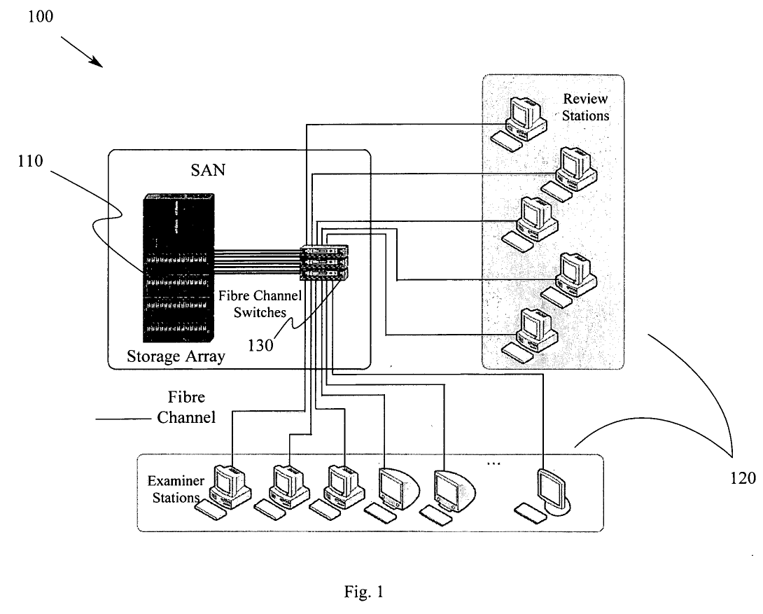

FIG. 1 illustrates a storage area network (SAN) 100 according to an embodiment of the present invention. The SAN includes a storage subsystem that provides a storage array 110 for storing data thereon. The storage array 110 is attached to a number of servers or client workstations 120. The link from a computer 120 to the storage array 110 is made using Fibre Channel (FC) optical switches 130 that form a network (FC fabric). Multiple servers or workstations 120 may be attached to the SAN 100.

Typically, a SAN is installed in a server room, IT center or server closet within the building housing the SAN. In addition, different components of the SAN are often located in different physical locations. However, a transportable SAN (TSAN) according to an embodiment of the present invention should have the same benefits and advantages of a normal SAN. The transportable SAN should also be transportable such that it can readily move it to a location where data is collected.

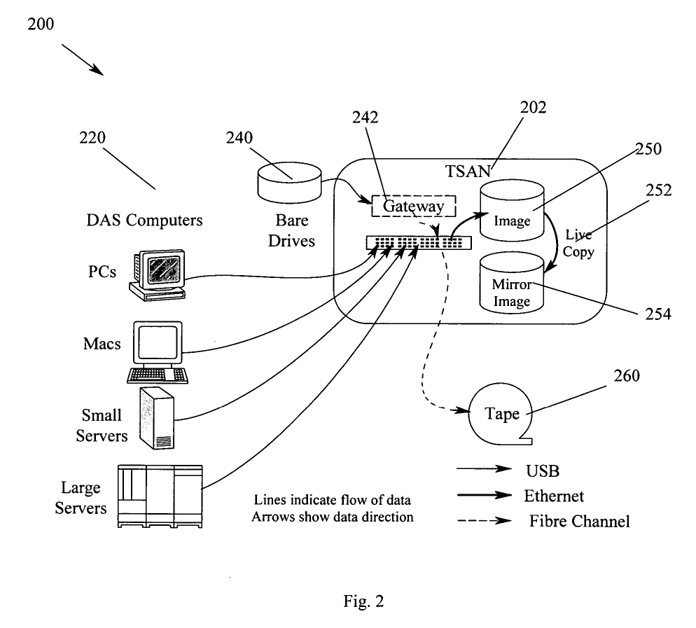

FIG. 2 is a functional diagram 200 of data collection using a transportable SAN according to an embodiment of the present invention. As shown in FIG. 2, computers 220 to be imaged are coupled to the TSAN 202 via installed Fibre Channel devices 230 such as Fiber Channel host bus adapters (HBAs). In some cases, drives 240 may be removed from their computers and attached to the TSAN 202 via a built-in interface 242, e.g., USB, in a TSAN gateway. The data is imaged to volumes 250 on the TSAN 202 and, if field analysis is to be performed, the data can be mirrored via live copy 252 to secondary volumes 254. Once the data collection is complete, the image volume 250 and image mirror volume 254 are separated and the data processing or analysis can proceed on the image volume 250 while the mirror volume 254 is left untouched. Tape backups 260 may also be created.

In FIG. 2, the transportable SAN 200 is configured in a transport mode for data collection from disparate computers with Direct Attached Storage (DAS) 220. This is a common situation where a site may have dozens or even hundreds of servers and client machines that need to be imaged and analyzed. The primary method of attachment here will be Fibre Channel using a built-in FC switch 230 in the TSAN 202. Transfer speeds may vary greatly in this scenario, e.g., the TSAN can easily sustain 80+ MB/s under these conditions when imaging 6 or more systems simultaneously.

The TSAN 202 is configured so that it can be transported easily from one location to another using common transportation methods. Once at a remote site, the TSAN 202 may be used to collect and store data in either of two basic modes of operation or a combination of both. The first mode is that of data collection for transportation back to an office SAN where the data can be analyzed or further processed on a stationary SAN. The second mode of operation is that in which the data may be collected on the TSAN 202 and then analyzed or processed on the TSAN 202 either on location or at a central site in the field. Within each of these two modes, there are different scenarios in which the data may be collected. In all of these scenarios, data verification techniques may be used to maintain the integrity of the data, e.g., to verify that the data has not been altered in any way.

The transportable SAN 202 provides easy provisioning so that a user can easily grow the pool of storage 250, 254 overall or just those volumes that they are using without having to re-architect the SAN or plan for down time. The overall pool of storage 250, 254 can scale to meet large requirements such as 10, 20 or 30 terabytes or: more. Each individual volume 250, 254 can be larger than any physical disk and can grow to the logical limit of the operating system. The volumes 250, 254 can be accessed by a first user and then easily reassigned to another user without the need to copy the data or even touch the data itself. However, as mentioned above, the mirror volume 254 may also be secured to maintain integrity of the data.

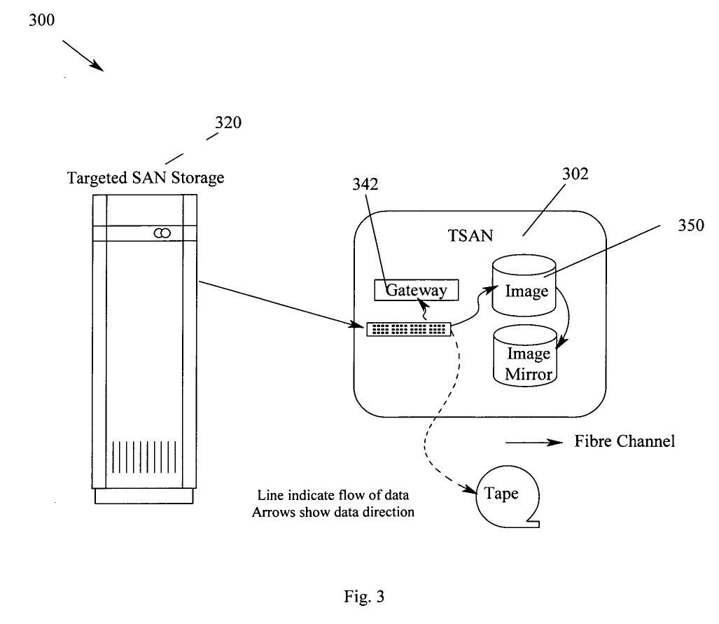

FIG. 3 is a functional diagram 300 of data collection from an on-site SAN using a transportable SAN according to an embodiment of the present invention. In FIG. 3, the transportable SAN 302 will usually be unable to attach directly to the targeted SAN 320 via a direct Fibre Channel link. This is due to the proprietary nature of nearly all SANs on the market today. In this situation, the targeted SAN 320 will be coupled to the transportable TSAN 302 via the built-in Fibre Channel switch 330, e.g., a Brocade 3852 16 port 2 Gb Fibre Channel switch.

As shown in FIG. 3, a built-in gateway 342 of the transportable SAN 302 is used as a data movement engine to copy data from the targeted SAN 320 to an image volume 350 of the TSAN 302. As in the previous scenario, data is imaged to volumes 350 of the TSAN 302 and can be simultaneously mirror to secondary volumes 354 and a tape device 360.

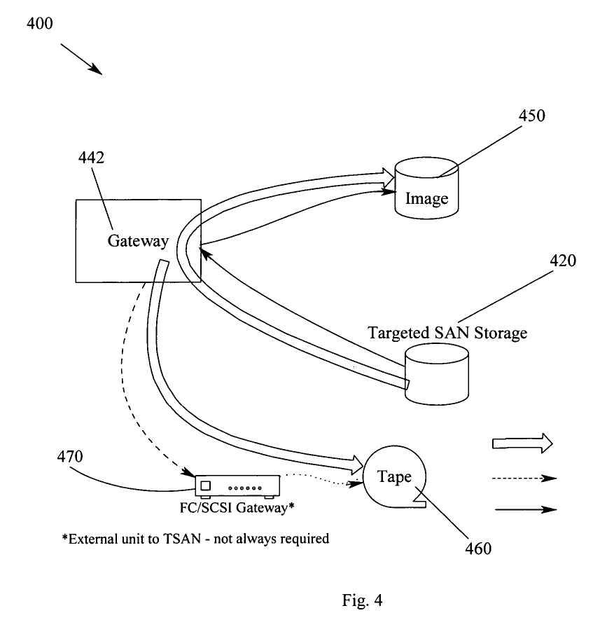

FIG. 4 is a flow diagram 400 showing data flow during gateway-based collection according to an embodiment of the present invention. The targeted SAN 420 is coupled to a gateway 442 via a Fibre Channel switch in the TSAN. The gateway 442 runs server software, e.g., Windows 2003, and sees the volumes in the targeted SAN 420. The gateway also sees the virtual disks (VDisks) of the TSAN image 450 that will be the destination of the image copy from the targeted SAN 420. A computer attached to a SAN sees the volumes on the SAN as standard ANSI SCSI disk drives. However, the volumes 450 may actually be a combination of many drives working together. The volume that a computer “sees” is called a virtual disk (VDisk) internal to the storage array. These volumes will be assigned drive letters such as “T:” for a volume in the targeted SAN 420 and “D:” for the destination image volume 450 in the TSAN. A simple copy or even drag/drop operation can then be used to copy from one volume to another. When this copy takes place, the data is copied from the targeted SAN 420 into the gateway 442 and then out to the image destination volume 450 in the TSAN. Tape backup 460 may received backup data via a FC/SCSI gateway 470. Other tools, e.g., EnCase, can be employed to perform the copy. The gateways 442 in the TSAN can run Linux instead of Windows Server software and then “dcfldd” (i.e., the forensic version of the UNIX® “dd command” for creating image copies) can be used to make these copies. In all cases, the flow is identical. The gateways 442 are used to bridge the logical gap between the targeted SAN 420 and the TSAN volumes 450.

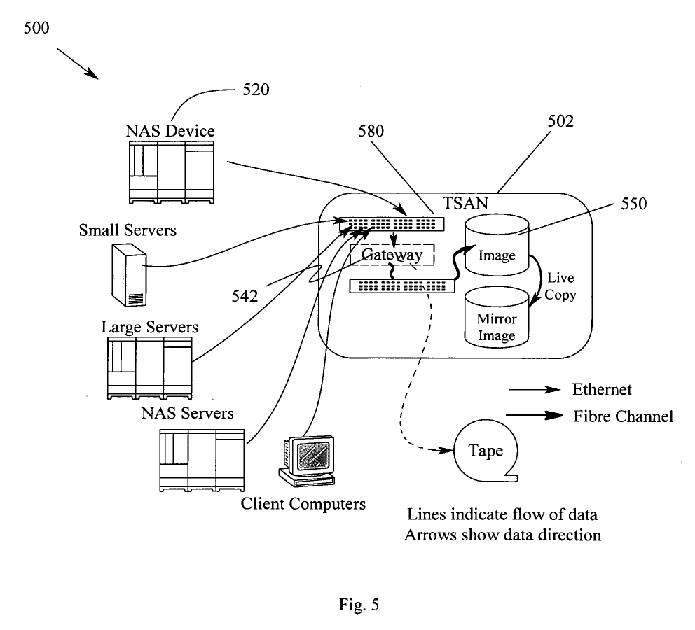

FIG. 5 is a functional diagram 500 of data collection from an on-site network attached storage (NAS) and network computers using a transportable SAN according to an embodiment of the present invention. In FIG. 4, the NAS devices 520 will range from Windows, UNIX and Novell servers that share directories to productized, proprietary network filers. The configuration shown in FIG. 5 also includes computers that are not configured for file sharing, but in which the data will be collected via the computers' Ethernet link. In all cases, the shared directories are available via the network and can be easily copied to the TSAN 502.

In FIG. 5, the targeted computers 520 are coupled to the TSAN 502 via the built-in Ethernet switch 580 in the TSAN 502. This configuration shares the same verification and simultaneous copy alternatives as the other scenarios. Data volumes from targeted computers 520 are seen by the TSAN gateway 542 and then copied to the image volume 550 by the gateway 542. This is the same data flow as shown in FIG. 4 with the TSAN gateway 542 acting as a data movement engine.

In cases where a targeted computer 520 does not have any drive shares and a Fibre Channel HBA cannot be installed (to enable collection via FIG. 2) a different method of collection will be used. In this case, the targeted computers 520 will boot from a CD, such as a Linux CD. Once booted, the computers 520 will find a shared volume from the TSAN gateway 542. Data is then copied from the targeted computer 520 to the shared TSAN volume 550. The data flow in this case is identical to that of FIG. 4. However, in this case, the data movement engine is the targeted computer 520 itself The TSAN gateway 542 is the NAS server that shares a TSAN volume 550 so that the targeted computer 520 can see the volume and copy data to it.

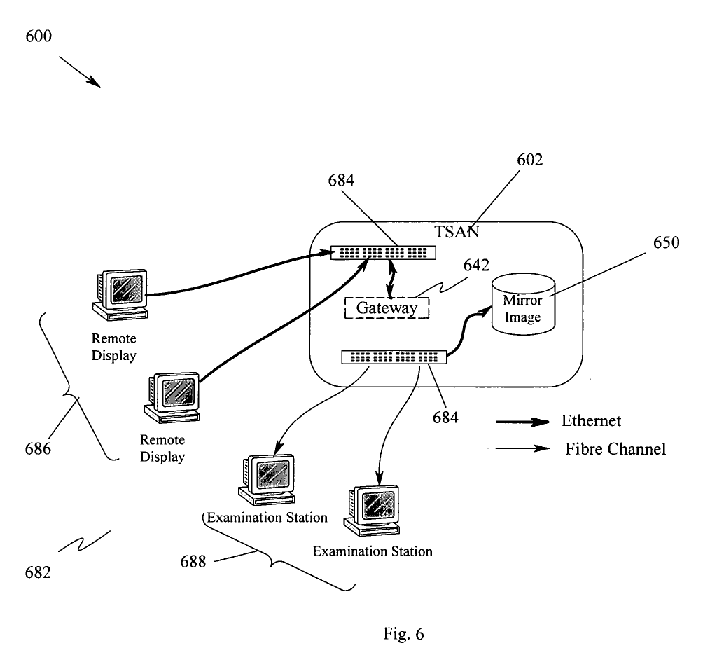

FIG. 6 is a functional diagram 600 showing examination, analysis, processing, etc. of data on a transportable SAN 602 according to an embodiment of the present invention. In such a configuration, the transportable SAN 602 provides a field lab mode for allowing field processing of data. In some cases, it may not be practical to ship the collected data back to a central examination site. Time constraints or other factors may require that the collected data be examined at the collection site or at a nearby field facility. For those cases, the built-in TSAN components can perform multiple duties and become an on-site data lab.

Once data is collected on the TSAN 602, the data can be analyzed directly on the TSAN 602 by making a mirror image 654 of the original data (if a mirror image was not done at collection time) and then analysis can be run on mirror image by the examination/processing stations 682. This mirror image 654 of collected data can also be used to spool the data to tapes for archival purposes (if tapes were not made with the original collection). Both operations (mirror image and tape spooling) are very simple and high speed.

The built-in gateways 642 can be used, for example, to run data analysis software, e.g., EnCase, iLook, FTK or any number of other analysis and examination tools. A keyboard/mouse and LCD monitor may be coupled to gateways 642 by a Keyboard/Video/Mouse (KVM) switch 684 so that multiple jobs running simultaneously can be monitored and controlled. The KVM switch 684 is used to couple multiple computers to the same terminal equipment. In this field lab mode, the TSAN 602 becomes a completely stand alone data analysis lab. One user can work at the built-in TSAN console and other users can be coupled to the gateway computers 686 via a remote desktop protocol (RDP), which enables console functions (keyboard, mouse, display, etc.) from one computer to be redirected to another computer over Ethernet, or via virtual network computing (VNC), which provides the same basic functionality as RDP but works with operating systems beyond Windows, most notably Linux. This allows users to run and monitor their own analysis and data processing programs.

External user stations 688 can also be coupled to the TSAN 602 via Ethernet or Fibre Channel just as targeted computers are attached. Then, each user can access individual volumes 654 and perform analysis independently as desired.

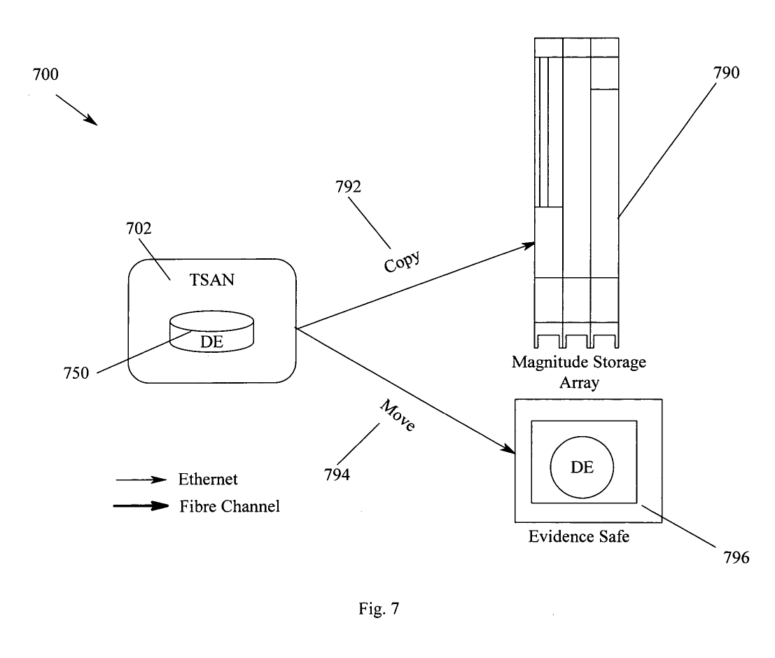

FIG. 7 is a functional diagram 700 showing a mode for copying of TSAN volumes to stationary office SANs according to an embodiment of the present invention. If the data 750 collected by the TSAN 702 is to be transported back to an office location where a stationary SAN 790 resides, then TSAN 702 will be coupled to the stationary SAN 790 either directly or via a Fibre Channel switch. The data volumes 750 on the TSAN 702 can be easily copied 792 to the stationary SAN 790 using replication services. In the diagram 700 shown in FIG. 7, the collected data volumes 750 on the TSAN 702 will be copied to the stationary SAN 790. Tape back-ups of the data can be made thereafter if they were not made on-site during the collection process. To preserve the validity of data, for example in the case of collected forensic computer data evidence, physical storage devices such as tapes, drives, etc., if made, can be moved 794 to evidence lockers or safes 796 for archiving. Once the data is copied from the TSAN 702 to the stationary SAN 790, processing of the data takes place using standard workflow and tools as is done in day-to-day operations using the stationary SAN.

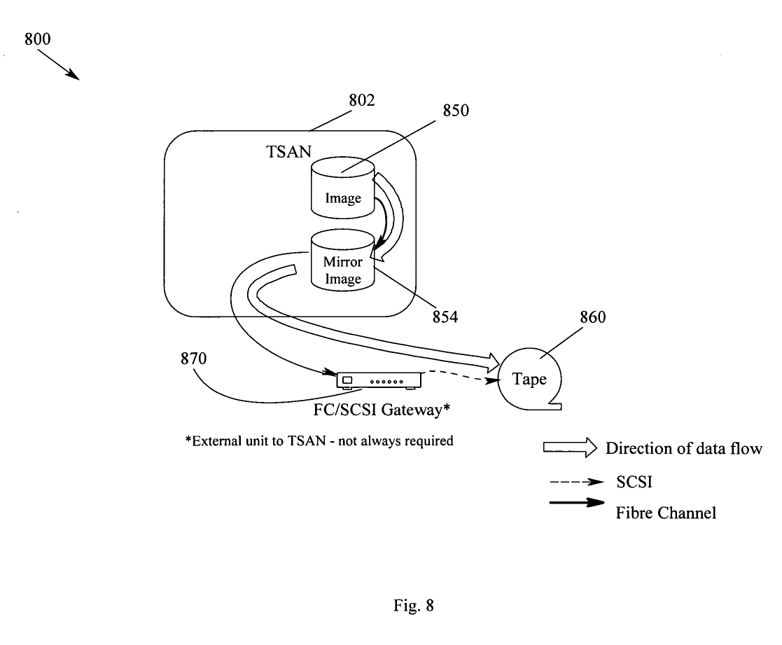

FIG. 8 is a functional diagram 800 showing flow of data from TSAN volumes to tape backup using image mirrors according to an embodiment of the present invention. Tape backup 860 may received backup data via a FC/SCSI gateway 870. As shown in FIG. 8, tape archives 860 of collected data can be made at several stages in the collection, analysis and processing operations. The most common three procedures will include simultaneous tape backup, mirror image tape backup and lab tape backup.

During simultaneous tape backup, tapes are made at the same time data is sent to the TSAN volume 850. For example, simultaneous backup to tape 860 may be performed when a computer is used to move data and the data is sent to both a TSAN volume 850 and a tape drive 860 simultaneously. For example, simultaneous tape backup may be commanded by using the UNIX tpipe command in an appropriate dcfldd command line.

The second procedure involves tapes 860 made from a mirror image 854 of the collected data in the TSAN 802. Tape backup 860 based upon the mirror image 854 may be performed on-site once the data is fully or partially collected. A second TSAN volume is created for the mirror volume 854 and the data is mirrored bit-for-bit to the second volume 854. Once the collection of data is completed, the original data volume 850 and the mirror image 854 are separated. Once separated, hashes may be run on both volumes 850, 854 to verify their integrity. Then, one volume may be used to spool tapes and the other used to perform analysis and other data processing operations.

The third procedure is similar to the mirror image tape backup procedure except that the tapes 860 are made once the TSAN 802 is back at the field office or lab. Again, FIG. 8 shows the basic data flow for spooling tapes during the collection process. An external Crossroads Fibre Channel/SCSI gateway 870 may be used to write to tape mechanisms 860 that support only SCSI setups.

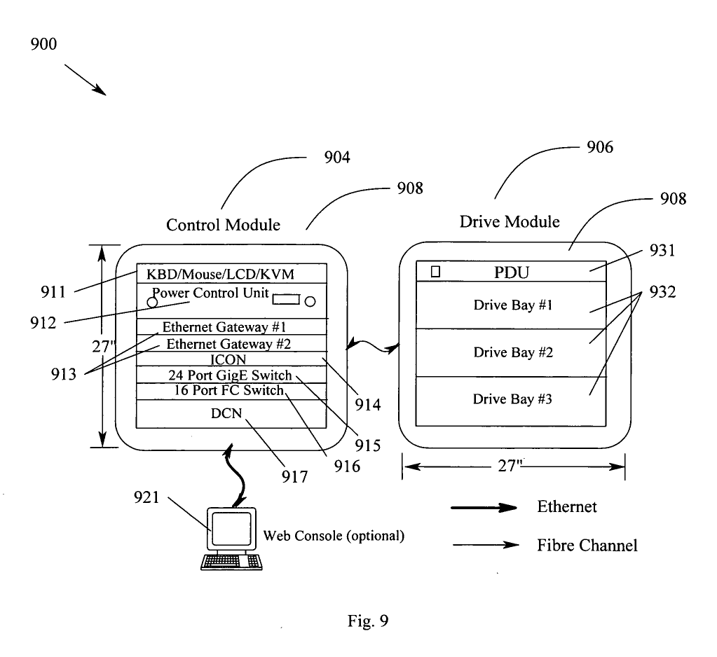

FIG. 9 is a diagram of TSAN components 900 according to an embodiment of the present invention. The TSAN 900 includes a control module 904 and a drive module 906. The TSAN 900 is constructed to ensure the robustness required for transportation. Thus, the TSAN control module may be implemented in a shock resistant shipping case 908, e.g., 10U shock resistant shipping case. The shock resistant case 908 houses all the “brains” of the TSAN 900. However, the TSAN 900 is typically configured so that data is not stored in the control module 904. The control module 904 may include a KVM switch 911, a power control unit 912, Ethernet gateways 913, Intelligent Controller (ICON) 914 for managing TSAN storage components, a Gigabit Ethernet switch 915, a Fibre Channel switch 916 and a controller for the TSAN drive modules, e.g., Dimensional Control Node (DCN) 917.

The TSAN control terminal 904 may include a notebook computer 921 running, for example, a Java Internet browser to manage the SAN 900, Ethernet 915 and FC 916 switches. The TSAN control module 904 may also run RDP and VNC for managing the Ethernet gateways 913. A web console may also be provided to provide Internet access and control. The drive module 906 includes a power distribution unit (PDU) 931 and drive bays 932. An automated power sequencer is provided at the power control unit 912 so that the TSAN 900 is more reliable and easier to set-up on location. The Gigabit Ethernet switch 915 allows for simultaneously attaching multiple computers to the gateway server and then to the TSAN 900. The Fiber Channel switch 916 allows the coupling of multiple simultaneous computers to the TSAN 900, e.g., via optical fiber HBAs installed in targeted computers or user workstations. The TSAN drive module 906 is also provided in a shock resistant shipping case 908 that houses all the data storage units. All data is stored here. The power distribution unit 931 provides power within the TSAN drive module 906. The drive bays 932 house disk drives. For example, each drive bay 932 may house multi-gigabyte hard drives to provide multi-terabytes of raw capacity per bay for 6 terabytes per drive bay module. More than one drive bay 932 can be implemented in a TSAN. Each TSAN module (i.e., control module 904 and drive module 906) requires a single 120 VAC 15 Amp outlet. Each unit or more than one unit can be powered by an appropriately sized portable 110 VAC-230 VAC power generator. Replication Services are embedded in the TSAN to enable quick and easy copying, mirroring and moving of data volumes from the TSAN to another Xiotech Magnitude 3D.

Intelligent Virtualization of Disk (IVD) is used to spread data volumes among all of the disk drives installed in the TSAN. IVD enables fully parallelized disk reads/writes and therefore negates the mechanical latency of an individual drive or small group of disk drives. All storage back-end details are isolated from the computers and applications attached to the TSAN thereby providing storage virtualization. This eliminates the burden of storage training and understanding that is required when using other SAN products. One benefit of this virtualization is that the system is much simpler and easier to use. Most functions of the TSAN platform can be implemented in seconds with a few mouse clicks or keystrokes, with little or no training.

The TSAN enables multiple mirrors, remote mirrors, changing RAID levels on-the-fly and many other functions through the virtualization architecture. The TSAN also provides a zero computer footprint, i.e., no computer (workstation, server, etc.) software is required. There are no computer agents or drivers required to support all of the functionality of the TSAN. Volumes from a TSAN are presented to an attached computer as standard ANSI SCSI drives. In the TSAN, these volumes are called Virtual Disks (VDisks) and are made up of a slice from each drive in the Drive Module(s). This means that there is no dependency between the computer and the TSAN volumes used by the computer.

The storage devices in the drive bays 932 of the TSAN 902 may include a cache-less design wherein high performance is achieved without using storage system cache. This lessens the system cost and lowers the risk of data loss from cache failures or other system failures that affect system cache. Drive types and sizes may be mixed and matched within the same storage frame without impacting performance or absolute capacity as an offshoot of the virtualization architecture. This architecture does not limit the size or speed of larger or faster disks when matched with slower or smaller disks.

When a RAID 5 volume is created, it is initialized before being made available for use. Once started, the requested space is allocated and then wiped clean of all pre-existing data before the volume is made available to a computer attached to the TSAN. The wipe process runs at 250 MB/s to 750 MB/s, depending on the number of drives in the system and activity levels, and cannot be stopped, aborted, interrupted or circumvented in any way. This process always takes place on new RAID 5 volumes and it ensures that new volumes cannot contain any digital residue. The TSAN does not have a traditional backplane architecture. Rather, the system is entirely built of individual components all coupled via redundant Fibre Channel optical cables. The result is an optical backplane that can be natively extended up to 300 meters between modules.

The TSAN can go from arrival on site to full operation in a very short period, e.g., under 15 minutes. The turnkey nature of the TSAN is such that no operator intervention is required to get a TSAN fully operational. Once the power is applied and the drive module(s) are coupled to the control module, the operator simply presses the power buttons and then waits for the unit to complete its power-on sequence. Once the power-on sequence is completed, the TSAN is ready for computer setup and data transfers.

These different modes of operation facilitate several different real-world scenarios in which a TSAN is required. Examples include large-scale data collection, covert data collection, collection in adverse conditions or where a remote lab for data analysis is necessary. For example, large-scale data collection may be needed to capture and analyze data of organizations that employ large SANs or multiple large servers on which they run their business. If data must be collected from one of these companies then the container (SAN) on which the data is deposited must necessarily be in the same class and scale.

The TSAN can be used to copy data from other SANs using gateway attachments to the SAN from which data is being collected. Using this technique, there is no SAN technology from which the TSAN cannot copy data. This configuration is shown in FIG. 3. The TSAN can also be used to image data directly from multiple servers simultaneously. This process is shown in FIG. 2. The TSAN also has the capability to couple to existing networks and copy data over the network. This is shown in FIG. 5.

For covert data collection, data is to be collected without the knowledge of the owner of the data, e.g., by law enforcement agencies. The data may belong to an individual or a business or it may be a military installation or other covert operation. Occasionally, data must be collected and processed from within a war zone or hostile territory. In addition, all the above scenarios may be implemented with remote lab requirements. For example, any of the above scenarios, as well as others, may require data collection at a large-scale business or in a hostile country and may require long periods based on the scale of the data. Interim analysis of the data is often required and the TSAN would enable interim analysis on-site and during the collection process. Of course, all of the above situations may be encountered at the same site. For this purpose, the TSAN includes a plurality of high-speed ports, e.g., 16 Fibre Channel and 24 Gigabit Ethernet ports and high performance gateways. The gateways themselves may include Gigabit Ethernet ports and USB ports each.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A transportable storage area network, comprising:
an enclosure;
at least one Fibre Channel device, disposed within the enclosure, for coupling to remote data devices;
at least one internal storage device, coupled to the at least one Fibre Channel device, the at least one internal storage device imaging data volumes of the remote data devices.

2. The transportable storage area network of claim 1 further comprising a gateway, coupled to the at least one Fibre Channel device, for providing a built-in interface for coupling directly to at least one bare storage device.

3. The transportable storage area network of claim 2, wherein the gateway coupled the at least one bare storage device to the at least one Fibre Channel device.

4. The transportable storage area network of claim 1, wherein the at least one internal storage device provides an image of the remote data devices and a mirror of the image, wherein the mirror image is created substantially at the same time the image on the remote storage devices are created.

5. The transportable storage area network of claim 1, wherein the internal storage devices provide an image of the remote data devices and a mirror of the image, wherein the mirror image is separated form the image of the remote data devices upon completion of data collection from the remote data devices.

6. The transportable storage area network of claim 1 further comprises a tape storage system coupled to the at least one Fibre Channel device for providing a backup of the image of the remote data devices or the mirror image.

7. The transportable storage area network of claim 1, wherein the least one Fibre Channel device comprises at least one Fibre Channel host bus adapter.

8. The transportable storage area network of claim 1, wherein the least one Fibre Channel device comprises at least one Fibre Channel switch.

9. The transportable storage area network of claim 8 further comprising a gateway for providing a data movement engine for copying data from a target storage area network to the at least one internal storage device.

10. The transportable storage area network of claim 1, wherein the at least one internal storage device comprises a plurality of storage devices configured as virtual disks.

11. The transportable storage area network of claim 1 further comprises a user interface for controlling copy operations.

12. The transportable storage area network of claim 1 further comprising an Ethernet switch for coupling to at least one target storage device, at least one Fibre Channel device for coupling to the at least one internal storage device and a gateway for providing a data movement engine for copying data from a target storage area network to the at least one internal storage device.

13. The transportable storage area network of claim 12, wherein the target storage devices comprise servers and network attached storage devices.

14. The transportable storage area network of claim 1 further comprising an Ethernet switch for coupling to at least one target storage device and at least one Fibre Channel device for coupling to the at least one internal storage device, the at least one target storage device being initialized as a data movement engine for copying data from the at least one target storage device to the at least one internal storage device.

15. The transportable storage area network of claim 1 further comprising a gateway for providing data processing tools access to the at least one internal storage device.

16. The transportable storage area network of claim 1 further comprises a secure data storage device for downloading data collected at a remote site.

17. The transportable storage area network of claim 1, wherein the enclosure comprises a shock resistant shipping case for mounting the at least one Fibre Channel device and at least one internal storage device.

18. The transportable storage area network of claim 1 further comprising a control module and a drive module.

19. The transportable storage area network of claim 18, wherein the drive module includes drive bays for mounting the at least one internal storage device and a power distribution unit for providing power to the drive module.

20. The transportable storage area network of claim 18, wherein the control module includes an automated power sequencer for providing reliable power-up at the remote location.

21. The transportable storage area network of claim 18, wherein the control module includes an intelligent controller for providing management operations.

22. The transportable storage area network of claim 18, wherein the control module includes a storage controller for managing the at least one internal storage device.

23. A method for providing data collection via a transportable storage area network, comprising:
coupling a targeted storage area network to a Fibre Channel switch of a transportable storage area network;
providing server operations at a gateway coupled to the Fibre Channel switch in the transportable storage area network to allow the gateway to access volumes in the targeted storage area network; and
copying data from the targeted storage area network to an image destination volume in the transportable storage area network via the gateway.

24. The method of claim 23, wherein the gateway views storage devices internal to the transportable storage area network as virtual disks, the storage devices providing a destination of the copy of data from the targeted storage area network.

25. The method of claim 23 further comprising creating a mirror of the image destination volume created from the targeted storage area network.

26. The method of claim 25, wherein the creating a mirror of the image destination volume created from the target storage area network further comprises creating a mirror volume by mirroring data collected in the destination volume bit-for-bit to the mirror volume and separating the mirror volume and the destination volume after data collection is completed.

27. The method of claim 26 wherein the creating a mirror of the image destination volume further comprises running hashes on both the destination volume and the mirror volume to verify integrity.

28. The method of claim 23 further comprising creating a tape backup of the mirror of the image destination volume.

29. The method of claim 28 further comprises spooling tapes with a first volume and performing data processing operations with a second volume.

30. The method of claim 28, wherein the creating a tape backup of the mirror of the image destination volume is performed simultaneously with the creation of the mirror of the image destination volume.

31. The method of claim 28, wherein the creating a tape backup of the mirror of the image destination volume is performed after the creation of the mirror of the image destination volume.

32. The method of claim 30, wherein the creating a tape backup after the creation of the mirror of the image destination volume comprises performing mirror image tape backup at a data collection site once the data has begun to be collected.
